(19) United States
(12) Patent Application Publication
(10) Pub. No.: US 2023/0220725 A1
(43) Pub. Date: Jul. 13, 2023

(54) WINDOW ASSEMBLY FOR A HUNTING BLIND

(71) Applicant: GRIZZLY COOLERS, LLC, Decorah, IA (US)

(72) Inventors: Greg Lewey, Decorah, IA (US); Luke Mount, Decorah, IA (US); Sam Mount, Decorah, IA (US); Jeremy Merrill, Ft Atkinson, IA (US)

(21) Appl. No.: 18/151,964

(22) Filed: Jan. 9, 2023

Related U.S. Application Data
(60) Provisional application No. 63/297,373, filed on Jan. 7, 2022.

(51) Int. Cl. E06B 7/23; E06B 1/36; E06B 5/00

(52) U.S. Cl. CPC E06B 7/2305; E06B 1/36; E06B 5/00; E04H 15/001

(57) ABSTRACT

The disclosure provided herein is directed to a window assembly that may be used for a hunting blind. The window assembly may have a frame gasket configured to go over a circumferential edge of a shell opening in a shell of the hunting blind. The window assembly may include a frame assembly with an exterior frame and interior frame matingly connect to one another thereby compressing the frame gasket to provide a seal without the use of fasteners or adhesive to connect to the frame assembly with the shell.

### CROSS REFERENCE TO RELATED APPLICATION

This application claims the benefit U.S. Provisional Patent Application Ser. No. 63/297,373 filed Jan. 7, 2022, the contents of this applications are hereby incorporated by reference in their entirety.

### BACKGROUND OF THE INVENTION

This disclosure generally relates to a window assembly. More specifically, the disclosure, in various aspects, relates to window assembly used in relation to a hunting blind (or blinds).

Hunting often requires a hunter to be exposed to environmental conditions (e.g., weather and temperature) in undeveloped areas for extended periods of time. Avoiding detection while hunting is also a paramount consideration. If a hunter is seen, heard, or smelled, game will avoid the area the hunter is located. To protect themselves from these elements and avoid detection, hunters often use blinds to provide the hunter protection from the elements and to obscure the location of the hunter by having an exterior that is camouflaged.

The remote locations that hunting may take place requires in most instances that blinds be configured for mobility, especially in rough and crowded terrain that limits access. Similarly, blinds are often relocated or stored throughout or at the end of each hunting season for a variety of reasons. To facilitate this mobility and protection, blinds are often made of light weight materials such as low-density polyethene and the like.

While inside the blind, hunters must be able to see their surroundings, produce calls to attract game, and fire a hunting implement, such as a long gun, at game. To this end, window assemblies are known in the art that cover openings formed in a shell of the blind. A pane of the window assembly is often openable to allow the hunting implement to pass through the window assembly and to broadcast calls to bring game closer. While useful, the combination of light weight plastics, such as polyethene, and the need to secure a window assembly has a number of deficiencies.

Low-density polyethene, and similar materials, are largely nonstick in nature making connection of the window assembly difficult. This requires a multitude of fasteners to secure the window, which requires that numerous holes be drilled through the shell for the fasteners or connection members to pass through the window assembly and shell. Likewise, the nonstick quality of these materials requires a substantial amount of adhesive to be applied to seal the window assembly so that the outside elements cannot leak through. This process is time consuming, messy, and laborious.

Low-density polyethene, and similar materials also has a large rate of expansion and contraction. These changes cause the fasteners and adhesive to be less effective, ultimately leading to the window assembly leaking. Hence, known window assemblies are difficult to manufacture, repair, and replace.

Thus it is a primary aspect of this disclosure to provide a window assembly that improves upon the art.

Another aspect of this disclosure is to provide a window assembly that eliminates drilling fastener openings in a shell and the use of an adhesive to seal the window assembly.

Yet another aspect of this disclosure is to provide a window assembly that maintains a seal as a shell of a blind expands and contracts.

Another aspect of this disclosure is to provide a window assembly that provides a frame assembly that is independent (i.e., not directly affixed by a fastener or an adhesive) from a shell of a blind.

Yet another aspect of this disclosure is to provide a window assembly that is airtight and watertight.

Another aspect of this disclosure is to provide a window assembly that simplifies manufacture and repair.

Yet another aspect of this disclosure is to provide a window assembly that reduces the number of parts necessary for manufacture.

These and other aspects, features, and advantages of the invention will become apparent from the specification and claims.

### SUMMARY OF THE INVENTION

The disclosure provides various aspects of a window assembly

In some aspects of the disclosure, broadly described herein, the techniques relate to a window assembly including: a frame assembly having an exterior frame and an interior frame; a frame gasket received between the exterior frame and the interior frame; the exterior frame having a first flange and the interior frame having a second flange, wherein the first flange and the second flange engage the frame gasket; a pane gasket received in the interior frame; and a pane connected to the interior frame.

In some aspects, broadly described herein, the techniques relate to a window assembly further including the interior frame having a third flange, wherein the third flange extends over and engages a gasket surface of the frame gasket.

In some aspects, broadly described herein, the techniques relate to a window assembly further including a shell having a shell opening, wherein the frame gasket is received over a circumferential edge over the shell opening.

In some aspects, broadly described herein, the techniques relate to a window assembly further including a cavity extending between a gasket surface of the frame gasket and the circumferential edge.

In some aspects, broadly described herein, the techniques relate to a window assembly wherein the frame gasket is U shaped formed by an interior flange and an exterior flange of the frame gasket extending outwardly away from the gasket surface.

In some aspects, broadly described herein, the techniques relate to a window assembly further including the interior frame having a third flange that extends over and engages the gasket surface such that the frame gasket is held in place over the circumferential edge.

In some aspects, broadly described herein, the techniques relate to a window assembly wherein the frame assembly is independent of the shell such that the frame assembly is not affixed to the shell.

In some aspects, broadly described herein, the techniques relate to a window assembly further including the exterior frame and the interior frame matingly connected inward from the frame gasket.

In some aspects, broadly described herein, the techniques relate to a window assembly further including the exterior frame having a first plurality of frame posts and the interior frame post having a second plurality of frame posts, a plurality of frame fasteners that each of the plurality of frame fasteners are received through one of the first plurality of frame posts and one of the second plurality of frame posts, wherein the first plurality of frame posts and the second plurality of frame posts are positioned inwardly from the frame gasket.

In some aspects, broadly described herein, the techniques relate to a window assembly further including a pane assembly having a pane, a hinge assembly having a friction hinge, a handle assembly having a connection bracket, and a latch assembly having a bushing received in a post, wherein the bushing has an outer edge having a frictional engagement with the post such that the post cannot be rotated without manual intervention.

In some aspects, broadly described herein, the techniques relate to a window assembly further including the exterior frame having a third flange and a fourth flange, the interior frame having a fifth flange, a sixth flange, and a seventh flange.

In some aspects, broadly described herein, the techniques relate to a window assembly wherein the third flange engages the interior frame, and the first flange and the second flange extend towards each other in alignment.

In some aspects, broadly described herein, the techniques relate to a window assembly further including the sixth flange extending between the first flange and the third flange.

In some aspects, broadly described herein, the techniques relate to a window assembly further including a shell having a shell opening, wherein the frame gasket is received over a circumferential edge over the shell opening.

In some aspects, broadly described herein, the techniques relate to a window assembly further including the fourth flange and the seventh flange engaging the shell below the frame gasket.

This has outlined, rather broadly, the features, advantages, solutions, and benefits of the disclosure in order that the description that follows may be better understood. Additional features, advantages, solutions, and benefits of the disclosure will be described in the following. It should be appreciated by those skilled in the art that this disclosure may be readily utilized as a basis for modifying or designing other structures and related operations for carrying out the same purposes of the present disclosure. It should also be realized by those skilled in the art that such equivalent constructions and related operation do not depart from the teachings of the disclosure as set forth in the appended claims. The novel features, together with further objects and advantages, will be better understood from the following description when considered in connection with the accompanying Figures. It is to be expressly understood, however, that each of the Figures is provided for the purpose of illustration and description only and is not intended as a definition of the limits of the present disclosure.

### BRIEF DESCRIPTION OF THE DRAWINGS

FIG. 1 is a front view of a window assembly according to an aspect of the disclosure;

FIG. 2 is a front perspective view of a window assembly according to an aspect of the disclosure;

FIG. 3 is a rear perspective view of a window assembly according to an aspect of the disclosure;

FIG. 4 is a front exploded view of a window assembly according to an aspect of the disclosure;

FIG. 5 is a side view of a window assembly according to an aspect of the disclosure;

FIG. 6 is a cross-sectional side view of a window assembly according to an aspect of the disclosure as indicated by FIG. 5;

FIG. 7 is a front perspective view of a window assembly according to an aspect of the disclosure;

FIG. 8 is a rear perspective view of a window assembly according to an aspect of the disclosure;

FIG. 9 is a front perspective view of a window assembly according to an aspect of the disclosure;

FIG. 10 is a rear perspective view of a window assembly according to an aspect of the disclosure;

FIG. 11 is a front perspective view of a window assembly according to an aspect of the disclosure;

FIG. 12 is a perspective view of a window assembly according to an aspect of the disclosure;

FIG. 13 is a perspective view of a window assembly according to an aspect of the disclosure; and

FIG. 14 is a side view of a window assembly according to an aspect of the disclosure.

### DETAILED DESCRIPTION

The disclosure described herein is directed to different aspects of a window assembly. The detailed description set forth below, in connection with the appended drawings, is intended as a description of various configurations and is not intended to represent the only configurations in which the concepts described herein may be practiced. These descriptions include specific details for the purpose of providing a thorough understanding of the various concepts. It will be apparent, however, to those skilled in the art that these concepts may be practiced without these specific details. In some instances, well-known structures and components are shown in block diagram form in order to avoid obscuring such concepts. As described herein, the use of the term “and/or” is intended to represent an “inclusive OR”, and the use of the term “or” is intended to represent an “exclusive OR”.

The disclosure is described herein with reference to certain aspects, iterations, embodiments, and examples but it is understood that the disclosure can be embodied in many different forms and should not be construed as limited to the aspects set forth herein. In particular, the disclosure is described herein in regards to a hunting blind or blind, but it is understood that the disclosure can be used in conjunction with an structure wherein a window assembly is conventionally presented, e.g., playhouse, etc. Additionally, elements described as being located on either the exterior frame can conversely be located on interior frame and vice versa.

Although the terms first, second, etc. may be used herein to describe various elements or components, these elements or components should not be limited by these terms. These terms are only used to distinguish one element or component from another. Hence, a first element discussed herein could be termed a second element without departing from the teachings of the present application. It is understood that actual systems or fixtures embodying the disclosure can be arranged in many different ways with many more features and elements beyond what is shown in the drawings. For the same or similar elements or features, the same reference numbers may be used throughout the disclosure.

It is to be understood that when an element or component is referred to as being “on” another element or component, it can be directly on the other element or intervening elements may also be present. Furthermore, relative terms such as “between”, “within”, “below”, and similar terms, may be used herein to describe a relationship of one element or component to another. It is understood that these terms are intended to encompass different orientations of the disclosure in addition to the orientation depicted in the figures.

With reference to the Figures aspects of a window assembly 10 are shown according to the disclosure. The window assembly 10 comprises one or more of a frame assembly 12 having one or more of a frame gasket 14, an exterior frame 16, and an interior frame 18, and a pane assembly 20 having one or more of a pane gasket 22, a pane 24, a hinge assembly 26, a handle assembly 28, and a latch assembly 30. The frame assembly 12, in some aspects of the disclosure, is positioned within a shell opening 32 in a shell 34 of a blind 36. In still further aspects described further herein, the frame gasket 14 is positioned over a circumferential edge 38 of the shell opening 32 in the shell 34. The exterior frame 16 and the interior frame 18 are matingly connected to one another with the shell 34 positioned between the exterior frame 16 and the interior frame 18. When connected, the exterior frame 16 and the interior frame 18 compress the frame gasket 14 thereby forming a watertight and/or airtight seal between the window assembly 10 and the shell 34 while the frame assembly 12 remains independent of the shell 34 (i.e., meaning that the exterior frame 16 and the interior frame 18 are not affixed to the shell 34 by fasteners and/or adhesive). In this way, the stated objectives, among others, are achieved.

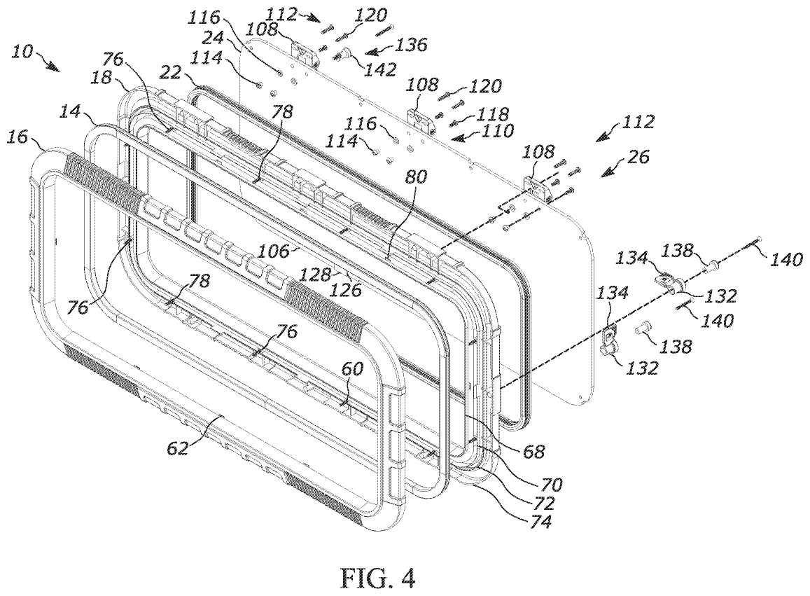

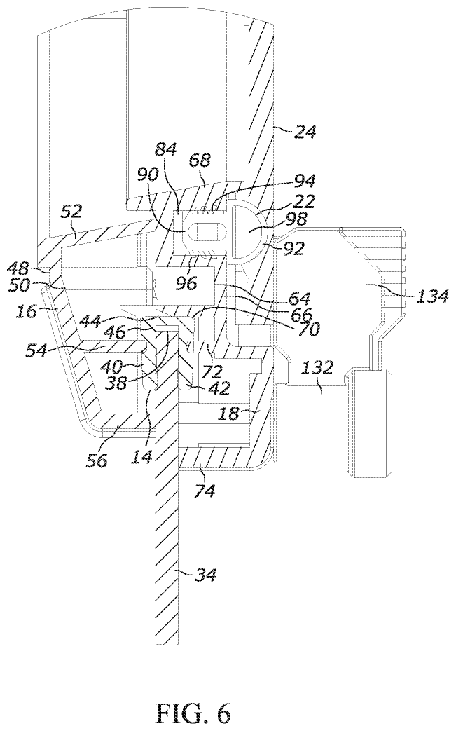

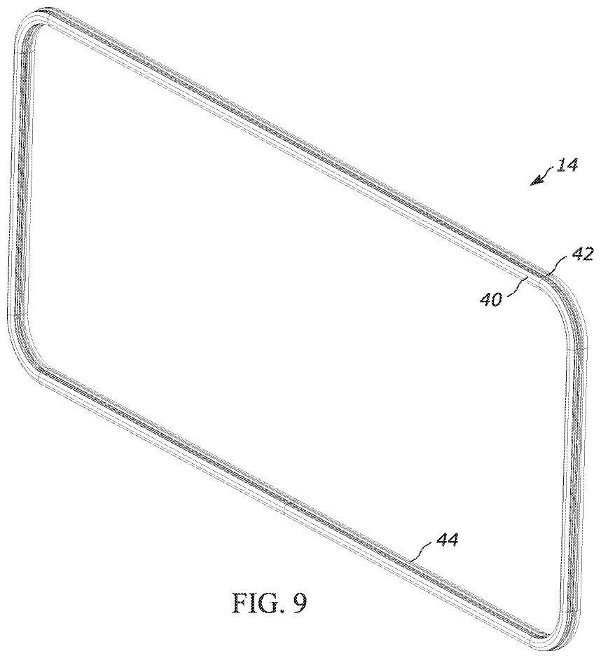

In yet further aspects, the frame gasket 14 has a generally “U” shape comprised of an exterior flange 40 and an interior flange 42 that extends from a gasket surface 44 extending between the exterior flange 40 and the interior flange 42. As seen in an illustrative aspect according to at least FIGS. 6 and 9, the exterior flange 40 and the interior flange 42 extend perpendicularly outward from the gasket surface 44 in substantially parallel spaced apart alignment with each other. As other aspects, seen in at least FIGS. 4, 6, and 9, the frame gasket 14 is continuous such that frame gasket 14 is or can be positioned along the entirety of the circumferential edge 38 of the shell opening 32. In still further aspects, the frame gasket 14 is made of closed-cell rubber foam, which provides a superior fitment and securement during assembly as described herein. In certain aspects of the present disclosure, the frame gasket 14 is configured such that when positioned over the circumferential edge 38, a space or cavity 46 is formed between the circumferential edge 38 and the gasket surface 44. In such aspects, the cavity 46 provides an area for the shell 34 to expand and contract without damaging the frame gasket 14 and also maintains the watertight and/or airtight seal between the window assembly 10 and the blind 36. This unique advantage is especially prominent when the shell 34 is made of low-density polyethene or similar material with a large rate of expansion and contraction based on ambient temperatures.

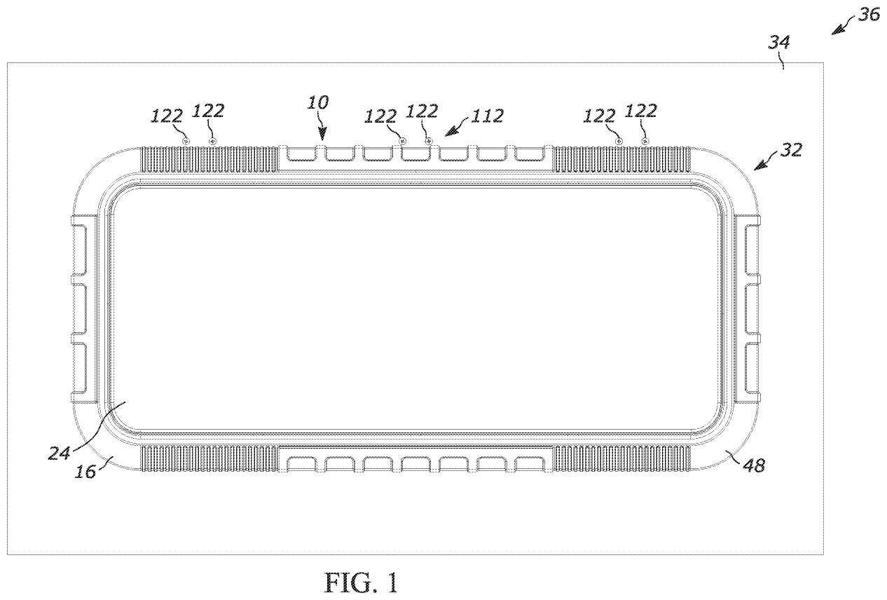

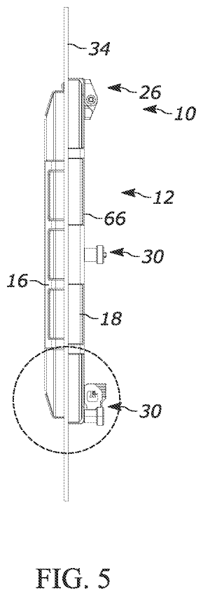

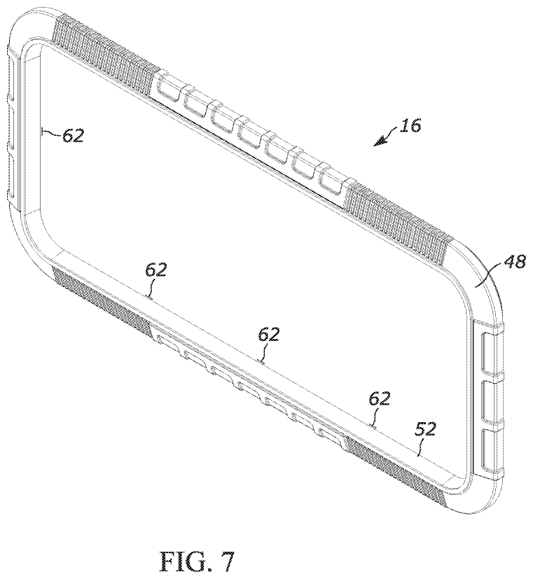

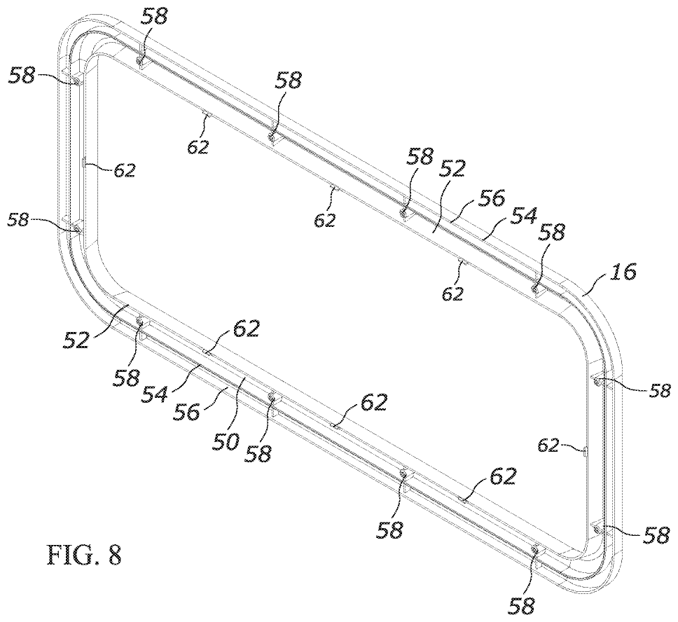

In other aspects, as shown at least in FIGS. 1-8, the exterior frame 16 is continuous and has an exterior facing surface 48 and an interior facing surface 50. In still other aspects, extending from the interior facing surface 50 and away from the exterior facing surface 48 is one or more of a first inner flange 52, a first middle flange 54, and a first outer flange 56, each of which, when present, extend around the entirety of the exterior frame 16 as shown in, at least, FIG. 8. In further aspects, positioned between the first inner flange 52 and the first middle flange 54 is a plurality of first frame posts 58 that receive a frame fastener 60 as described further herein. In still other aspects, a plurality of male connectors or clips 62 extend from the interior facing surface 50.

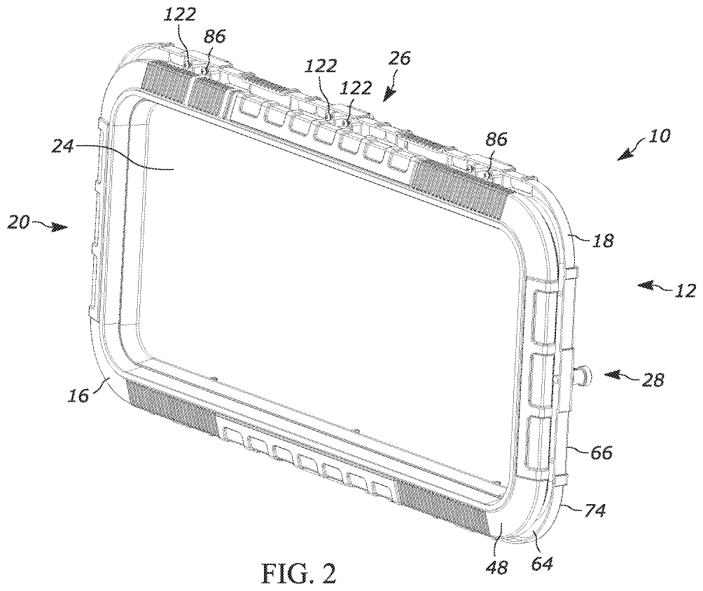

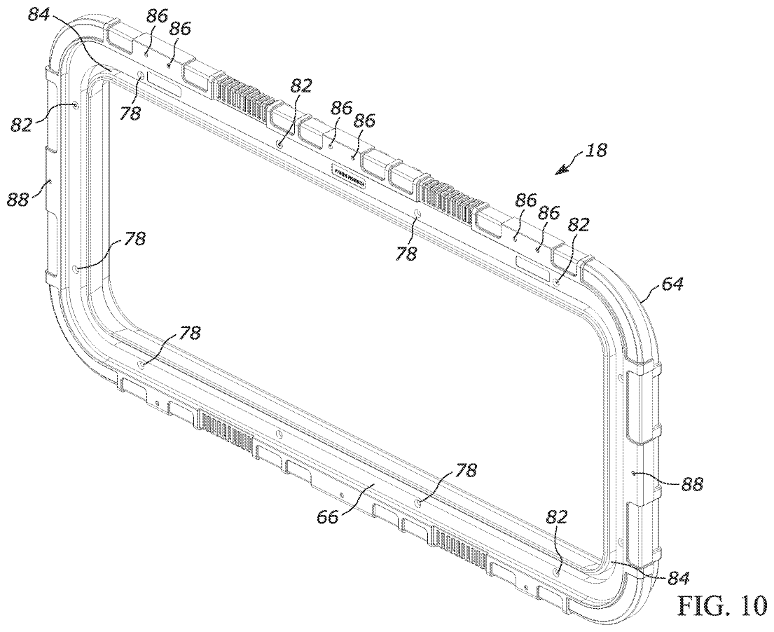

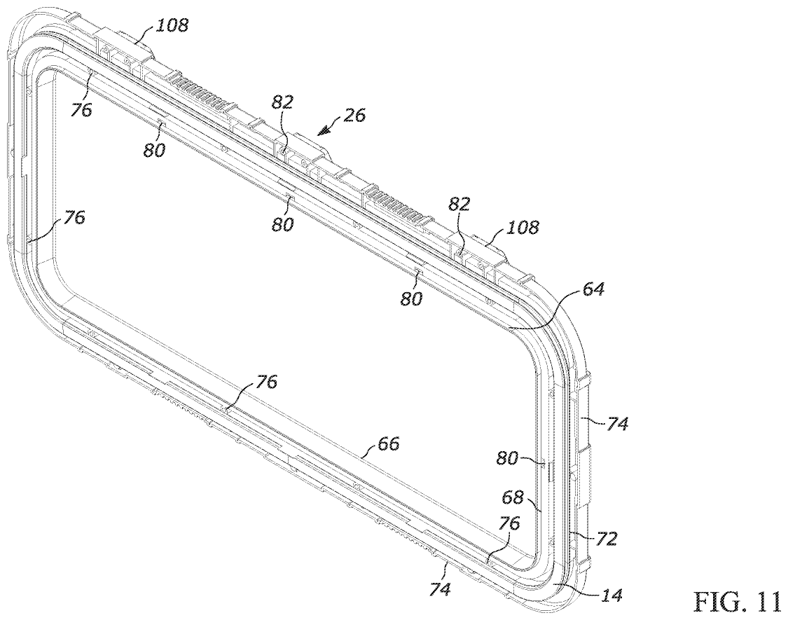

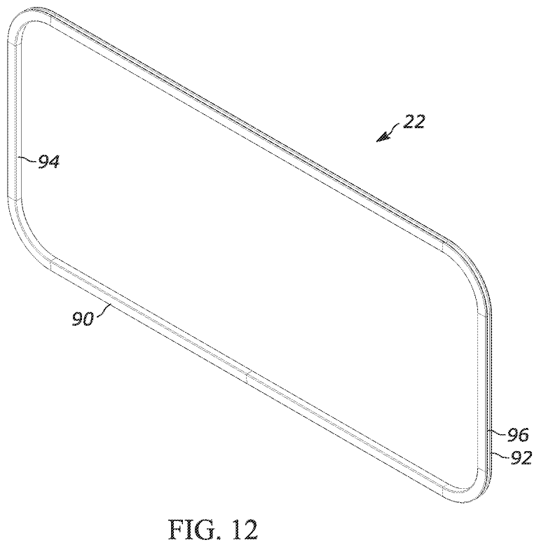

In still further aspects, as seen in at least FIGS. 2-6, 10, and 11, the interior frame 18 is continuous and has an exterior facing surface 64 and an interior facing surface 66. In further aspects according to the present disclosure, extending from the exterior facing surface 64 and away from the interior facing surface 66 is one or more of a second inner flange 68, a second middle flange 70, a third middle flange 72, and a second outer flange 74, each of which, when present, extend around the entirely of the interior frame 18 as shown in, at least, FIGS. 4 and 12. In some aspects, positioned between the second inner flange 68 and the second middle flange 70 is a plurality of second frame posts 76 that align with the plurality of first frame posts 58 and receive a frame fastener 78 when the exterior frame 16 and the interior frame 18 are connected as discussed herein. In further aspects, a plurality of female slots 80 extend from the exterior facing surface 64 that align with the plurality of male connectors 62 of the exterior frame 16 to provide a matingly connection as described herein. In yet further aspects, the interior facing surface 66 of the interior frame 18 comprises one or more of a plurality of frame connection openings 82, a continuous gasket slot 84 that receives the pane gasket 22, a plurality of hinge openings 86, and a plurality of latch openings 88 as described further herein. In some aspects, the exterior frame 16 and the interior frame 18 are made of polypropylene.

In an illustrative assembly, as seen in at least the depiction of FIG. 6, the frame gasket 14 is placed around the circumferential edge 38 of the shell opening 32 with the exterior flange 40 of the frame gasket 14 in engagement with one side of the shell 34 and the interior flange 42 on the opposing side of the shell 34. The frame gasket 14 is positioned such that the cavity 46 is formed between the exterior flange 40, the interior flange 42, the gasket surface 44, and the circumferential edge 38. The exterior frame 16 and the interior frame 18 are matingly connected with one another on opposing sides of the shell 34 through connection of the plurality of male connectors 62 of the exterior frame 16 and the plurality of female slots 80 of the interior frame 18. For the sake of clarity, the location of the plurality of male connectors 62 and the plurality of female slots 80 be positioned on the exterior frame 16 and/or interior frame 18. One or more of the frame fasteners 78 are passed through the plurality of first frame posts 58 and the plurality of second frame posts 76 via the frame connection openings 82. In such a configuration, the direct connection between the exterior frame 16 and the interior frame 18 occurs through the shell opening 32, i.e., the plurality of male connectors 62 and the frame fastener 78 do not pass through the shell 34.

When the exterior frame 16 and the interior frame 18 are connected to one another, the first inner flange 52 of the exterior frame 16 engages the exterior facing surface 64 of the interior frame 18. The second middle flange 70 of the interior frame 18 extends between the first inner flange 52 and the first middle flange 54 of the exterior frame 16. In certain aspects, the second middle flange 70 is positioned further inward than the gasket surface 44 of the frame gasket 14 such that the second middle flange 70 engages the gasket surface 44 to maintain the position of the frame gasket such that the frame gasket 14 is prevented from dislodging from engagement with the shell 34. The first middle flange 54 of the exterior frame 16 engages and compresses the exterior flange 40 of the frame gasket 14 against the shell 34, whereas the third middle flange 72 each engages and compresses the interior flange 42 of the frame gasket 14. As this engagement is continuous around the entirety of the shell opening 32, a watertight and/or airtight seal is formed without the use of passing fasteners through the shell 34 or the use of adhesive. The first outer flange 56 and the second outer flange 74 engage the shell 34 below the frame gasket 14. As such, the frame assembly 12 is of two-piece construction that is independently connected with the shell 34.

In still other aspects of the present disclosure, as seen in at least FIGS. 4, 6, and 12, the pane gasket 22 comprises one or more of a stem 90, a cap 92, a first set of angled flanges 94, and a second set of angled flanges 96. In further aspects, the cap 92 has a cavity 98 that allows the cap 92 to compress when pressure is applied. In still other aspects, the first set of angled flanges 94 and the second set of angled flanges 96 extend outwardly and angularly towards the cap 92 from opposing sides of the stem 90. The first set of angled flanges 94 and the second set of angled flanges 96 are received within the continuous gasket slot 84 such that the first set of angled flanges 94 and the second set of angled flanges 96 compress towards the stem 90 when assembled with the interior frame 18 and resist removal. In certain such aspects, the cap 92 is positioned outside of the continuous gasket slot 84. In another aspect, the pane gasket 22 is continuous such that the pane gasket 22 is received within the entirety of the continuous gasket slot 84. In still other aspects, the pane gasket 22 is a compression gasket and/or made of thermoplastic elastomer such that the pane gasket 22 remains flexible in wide range of temperatures, including cold temperatures that are typical during hunting seasons.

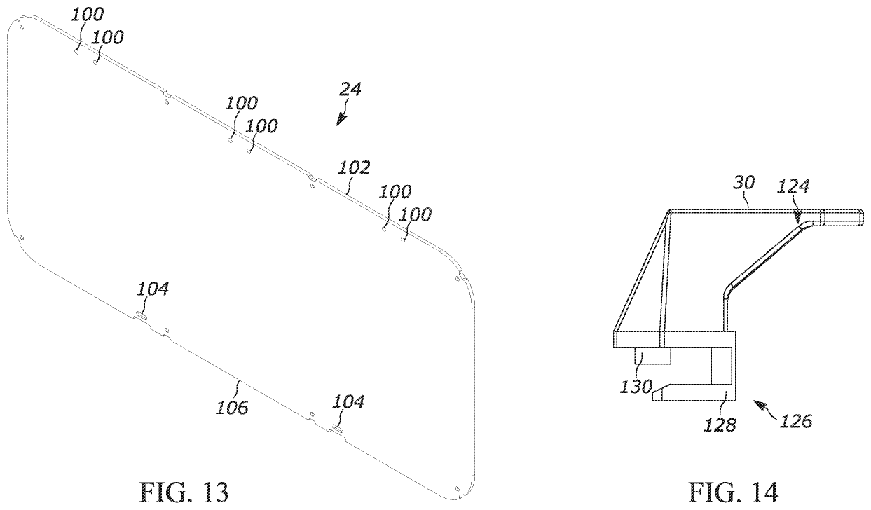

In still further aspects, as seen in at least FIGS. 1-4, 6, and 13, the pane 24 comprises one or more of a hinge opening 100, which in other aspects are positioned along and adjacent an upper edge 102 of the pane 24. The one or more of the hinge opening 100 are used to connect the hinge assembly 26 to the pane 24. In other aspects, the pane 24 comprises one or more of a handle opening 104, which in further aspects are positioned along and adjacent a lower edge 106 of the pane 24. In some certain aspects, the one or more of the handle opening 104 is shaped as an elongated lateral slot that facilitates connection with the handle assembly 28 as described herein. In some aspects, the pane 24 is made of acrylic to provide a transparent barrier to the elements that is also shatterproof or resistant.

In yet further aspects, as seen in at least FIGS. 1-5 and 11, the hinge assembly 26 comprises one or more of a hinge 108, a pane connection assembly 110 that connects the hinge assembly 26 to the pane 24, and a frame connection assembly 112 that connects the hinge assembly 26 to the frame assembly 12 and/or the shell 34. In some aspects, the hinge 108 is a friction hinge such that when the pane 24 is lifted the hinge 108 maintains the position of the pane 24 when the pane 24 is no longer being manually manipulated.

In other aspects, the pane connection assembly 110 is comprised of one or more of a binding post 114, one or more of a washer 116, and one or more of a pane fastener 118, which in some particular aspects is a pan head screw. The pane fastener 118, in some aspects passes through the hinge 108 one side of the pane 24 and is received through the washer 116 and the binding post 114 on the other side of the pane 24 thereby securing the hinge 108 to the pane 24.

In further aspects, the frame connection assembly 112 is comprised of one or more of an interior hinge fastener 120 and an exterior hinge fastener 122, which in certain embodiments both are configured with thread rolling to better engage plastic and in still further aspects, are flat head screws. In some aspects, the interior hinge fastener 120 passes through the hinge 108 and into one of the plurality of frame connection openings 82 on the interior frame 18. In still other aspects, the exterior hinge fastener 122 is passed through the shell 34 and also into the same of the plurality of frame connection openings 82. In this way, the frame connection assembly 112 is more securely anchored, which is useful as the hinge assembly 26 is one of the few manipulatable elements of the disclosure.

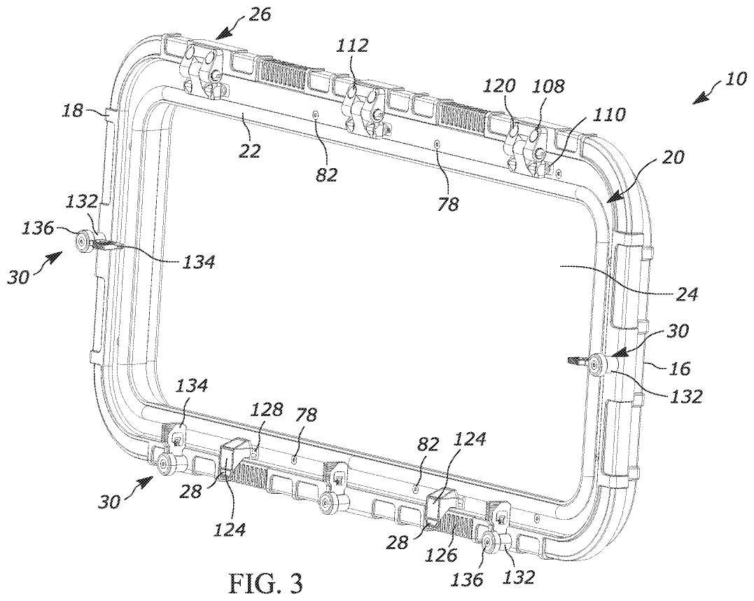

In still other aspects, as shown in FIGS. 3, 4, and 14, the handle assembly 28 comprises one or more of a grip 124 and a connection bracket 126 comprising one or more of a handle flange 128 and a notch 130. The grip 124 in some aspects extends outwardly and downwardly from the pane 24 to allow easy manual gripping of the handle assembly 28. In still other aspects, the connection bracket 126 connects the handle assembly 28 to the pane 24. In still further aspects, the handle flange 128 extends rearwardly from the grip 124 and towards the exterior frame 16. In yet further aspects, the handle flange 128 is J shaped to receive and connect to the lower edge 106 of the pane 24. In some such aspects, the notch 130 extends rearwardly from and is received in the handle opening 104 to secure the connection of the handle assembly 28 to the pane 24 in a clipping fashion.

In yet other aspects, as shown in FIGS. 2-6, the latch assembly 30 comprises one or more of a post 132, a latch grip 134, and a latch connection assembly 136 that connects the latch assembly 30 to the frame assembly 12, which in some aspects includes the latch connection assembly 136 rotatably connecting to the interior frame 18 by way of one or more of the plurality of latch openings 88. In certain aspects of the disclosure, the latch connection assembly 136 comprises a bushing 138 that is received in the post 132 through which a latch fastener 140 is received to connect the latch assembly 30 to the interior frame 18 through each of the plurality of latch openings 88. In certain aspects, the bushing 138 has an outer edge 142 having a frictional engagement with the post 132 that inhibits movement without manual intervention akin to a friction hinge discussed herein. In this way, the rotation of the latch assembly 30 about the latch fastener 140 is selective. In some aspects, the latch fastener is configured with thread rolling for plastic engagement and still further aspects is a pane head screw.

In an illustrative usage, each of the latch grip 134 are configured to extend over a path that the pane 24 travels when being opened or closed due to the connection with the hinge assembly 26. To open the window assembly 10, each of the latch grip 134 are rotated to not block the path the pane 24 travels. The presence of the hinge 108 being a friction hinge maintains the position of the pane 24 as it is opened so that a hunter does not need to hold the window assembly 10 open when aiming, using a call, or obtaining an entirely unobstructed view through the shell opening 32. To close the window assembly 10, the pane 24 is lowered and compressed against the pane gasket 22 and each of the latch grip 134 are rotated to prevent the pane 24 from moving. Due to the compression of the pane gasket 22, and particularly the cap 92, by the pane 24, a watertight and/or airtight seal is provided.

Therefore, a window assembly 10 has been provided that eliminates drilling fastener openings in a shell and the use of an adhesive to seal the window assembly; maintains a seal as a shell of a blind expands and contracts; provides a frame assembly that is independent (i.e., not directly affixed by a fastener or an adhesive) from a shell of a blind; is airtight and watertight; simplifies manufacture and repair; reduces the number of parts necessary for manufacture, and improves upon the art.

From the above discussion and accompanying figures and claims it will be appreciated that the window assembly 10 offers many advantages over the prior art. Although the present disclosure and its advantages have been described in detail, it should be understood that various changes, substitutions, modifications, and alterations can be made herein without departing from the technology of the disclosure as defined by the appended claims. The scope of the present application is not intended to be limited to the particular configurations of the process, machine, manufacture, composition of matter, means, methods and steps described in the specification only expressly stated otherwise. As one of ordinary skill in the art will readily appreciate from the disclosure, processes, machines, manufacture, compositions of matter, means, methods, or steps, presently existing or later to be developed that perform substantially the same function or achieve substantially the same result as the corresponding configurations described herein may be utilized according to the present disclosure. Accordingly, the appended claims are intended to include within their scope such processes, machines, manufacture, compositions of matter, means, methods, or steps.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A window assembly comprising:
a frame assembly having an exterior frame and an interior frame;
a frame gasket received between the exterior frame and the interior frame;
the exterior frame having a first flange and the interior frame having a second flange, wherein the first flange and the second flange engage the frame gasket;
a pane gasket received in the interior frame; and
a pane connected to the interior frame.

2. The window assembly of claim 1 further comprising the interior frame having a third flange, wherein the third flange extends over and engages a gasket surface of the frame gasket.

3. The window assembly of claim 1 further comprising a shell having a shell opening, wherein the frame gasket is received over a circumferential edge over the shell opening.

4. The window assembly of claim 3 further comprising a cavity extending between a gasket surface of the frame gasket and the circumferential edge.

5. The window assembly of claim 4 wherein the frame gasket is U shaped formed by an interior flange and an exterior flange of the frame gasket extending outwardly away from the gasket surface.

6. The window assembly of claim 5 further comprising the interior frame having a third flange that extends over and engages the gasket surface such that the frame gasket is maintained in place over the circumferential edge.

7. The window assembly of claim 3 wherein the frame assembly is independent of the shell such that the frame assembly is not affixed to the shell.

8. The window assembly of claim 1 further comprising the exterior frame and the interior frame matingly connected inward from the frame gasket.

9. The window assembly of claim 1 further comprising the exterior frame having a plurality of first frame posts and the interior frame having a plurality of second frame posts, a plurality of frame fasteners that each of the plurality of frame fasteners are received through one of the plurality of first frame posts and one of the plurality of second frame posts, wherein the plurality of first frame posts and the plurality of second frame posts are positioned inwardly from the frame gasket.

10. The window assembly of claim 1 further comprising a pane assembly having a pane, a hinge assembly having a friction hinge, a handle assembly having a connection bracket, and a latch assembly having a bushing received in a post, wherein the bushing has an outer edge having a frictional engagement with the post such that the post cannot be rotated without manual intervention.

11. The window assembly of claim 1 further comprising the exterior frame having a third flange and a fourth flange, the interior frame having a fifth flange, a sixth flange, and a seventh flange.

12. The window assembly of claim 11 wherein the third flange engages the interior frame, and the first flange and the second flange extend towards each other in alignment.

13. The window assembly of claim 11 further comprising the sixth flange extending between the first flange and the third flange.

14. The window assembly of claim 11 further comprising a shell having a shell opening, wherein the frame gasket is received over a circumferential edge over the shell opening.

15. The window assembly of claim 14 further comprising the fourth flange and the seventh flange engaging the shell below the frame gasket.
